(19) United States
(12) Patent Application Publication
(10) Pub. No.: US 2003/0071838 A1
(43) Pub. Date: Apr. 17, 2003

(54) Intuitive computer data management system and method

(76) Inventors: Sayling Wen, Taipei (TW); Kuang Shin Lin, Taipei (TW); Zhu Wei, Tianjin (CN)

Correspondence Address: BIRCH STEWART KOLASCH & BIRCH, PO BOX 747, FALLS CHURCH, VA, 22040-0747, US

(21) Appl. No.: 09/974,883

(22) Filed: Oct. 12, 2001

(51) Int. Cl. G06F 3/00

(52) U.S. Cl. 345/705

(57) ABSTRACT

An intuitive computer data management system, includes a UI (User Interface), a categorizing module, and an accessing module. The UI provides at least one prompt to a user so that the user can follow the prompt to send an access request for computer readable data in one action. The categorizing module automatically determines the type of computer readable data according to the access request given by the user. The accessing module then processes the computer readable data according to the determined type.

### BACKGROUND OF THE INVENTION

1. Field of Invention

The invention relates to a computer data management system and, in particular, to a computer data management system which enables a user to follow prompts to access data stored therein in one action.

2. Related Art

Although existing personal computer operating systems (OS), such as Microsoft Windows and Linux OS, have many good designs and functions, they are still not intuitive and convenient enough in operations.

Feature-rich and sophisticated they may be, however, those very features and sophistication themselves also constitute, on many occasions, serious psychological barriers for computer-novices. These barriers automatically arise for many novice users as they attempt to use the computer not only because the typical PC OS is complex and feature-laden, but also because there are at least several procedural steps to take before any of the more simple and intuitive computer applications can be launched and used.

To power up a computer and bring up an application, a user has to boot up the system, access the physical interface of the system via devices such as a keyboard and/or mouse, locate the whereabouts of the particular application software from the desktop icon array, and then actually launch the application.

Even after the user has successfully brought the desired software application up and running, the process of using the application will most likely involve interacting with the application via one or more of several forms of user interfaces. Sometimes, a combination of these interfaces will have to be used. Typical of these user interfaces are graphical (GUIs) and multimedia types initiated through the use of a mouse, keyboard, microphone, and the like. However, since almost all of the most popular software application programs are marketed in English versions, and even the non-English version software programs inevitably contain English messages in the interfaces they provide, for non English-speaking or barely literate users, even these popular GUIs and other multimedia interfaces constitute obstacles to computer access and productive use.

Thus, an easy-to-use computer application software system should look, feel friendly and be encouraging rather than frightening. A friendly and encouraging application system should be fool-proof in that the user knows he or she will never physically damage the computer, crash the OS, or lose data simply by attempting different commands on the computer. A simple computer application system is therefore desirable for those intending to learn and use computers for the first time and then for simple daily activities such as keeping phone numbers and addresses, web browsing, and many other intuitive applications.

Taking data management in computers as an example, traditional operating systems use tree structures to management data in the systems. Such a data management structure does not have intuitive correspondence with the experience in real life. Beginners have to learn such concepts of “file”, “path”, and “folder” before using data in the computer system. This does not only increase the complexity of the computer in use but also intimidates the beginners.

To solve the above-mentioned problem, the traditional Windows OS provides the “shortcut” function. For example, when installing an application, an icon linking to the application can be created on the desktop. A user can directly call the application by clicking the icon using a mouse. In addition, the user can create an icon linking to some file on the desktop and click it to open the file by a mouse. Through this method, users can more intuitively select a file by clicking the corresponding shortcut.

If one wants to use the “shortcut” concept to manage data stored in the computer, he still has to create shortcuts on the desktop by himself. The OS cannot automatically sets shortcuts for all data files. In other words, the user still has to learn the previously mentioned concepts of “file”, “path”, and “folder” before he can use the “shortcut” concept to manage computer data. This is still unable to increase the beginner's efficiency in using the computer. Furthermore, if each data file in the computer has to have a shortcut, the computer display screen can be a mess to the user. It is of no use for data management.

If the computer data management system has an intuitive correspondence with the experience in real life, it will encourage the computer uses by those people who are not familiar with computers, thus promoting the sales and applications of computers and increasing the efficiency of computer manipulation. So it is a very important issue to provide a computer data management system that has an intuitive correspondence with the experience in real life.

### SUMMARY OF THE INVENTION

Pursuant to the above problems, it is an objective of the invention to provide an intuitive computer data management system and method, which has intuitive correspondence with the experience of real life.

Another objective of the invention is to provide an intuitive computer data management system and method, which can increase the efficiency of computer data management of a user.

To achieve the above objectives, the intuitive computer data management system according to the invention includes a UI (User Interface), a categorizing module, and an accessing module. The UI provides at least one prompt to a user so that the user can follow the prompt to send an access request for computer readable data in one action. In the embodiment, the so-called “one action” refers to the single action for inputting a request by, for instance, hitting a key on the keyboard. The categorizing module automatically determines the type of computer readable data according to the access request given by the user. The accessing module then saves or loads the computer readable data according to the determined type.

According to an aspect of the invention, when a user sends a saving request, the accessing module saves the data to a corresponding data set according to its type.

According to another aspect of the invention, when the user sends a single-type list request, the accessing module reads out a single-type list from the corresponding data set according to the data type and displays the single-type list data to the user via the UI.

According to still another aspect of the invention, when the user sends an all-type list request, the accessing module reads out an all-type list from the corresponding data set according to the data type and displays the all-type list data to the user via the UI.

The disclosed intuitive computer data management system automatically provides appropriate prompts to the user. The user only needs to follow the prompt to use the computer without memorizing any operational procedure or hot key combination.

The fact that the disclosed intuitive computer data management system automatically classifies data help increasing the beginner's efficiency in computer uses.

### BRIEF DESCRIPTION OF THE DRAWINGS

The invention will be fully understood from the detailed description given hereinbelow illustration only, and thus are not limitative of the invention, and wherein:

FIG. 1 is a schematic view showing the structure of an intuitive computer data management system according to a preferred embodiment of the invention;

FIG. 2 is a flowchart showing the procedure of an intuitive computer data management method according to a preferred embodiment of the invention;

FIG. 3A is a schematic view showing one screen of a user using the intuitive computer data management system of FIG. 1;

FIG. 3B is a schematic view showing another screen of a user using the intuitive computer data management system of FIG. 1; and

FIG. 3C is a schematic view showing yet another screen of a user using the intuitive computer data management system of FIG. 1.

### DETAILED DESCRIPTION OF THE INVENTION

The invention will be apparent from the following detailed description, which proceeds with reference to the accompanying drawings, wherein the same references relate to the same elements.

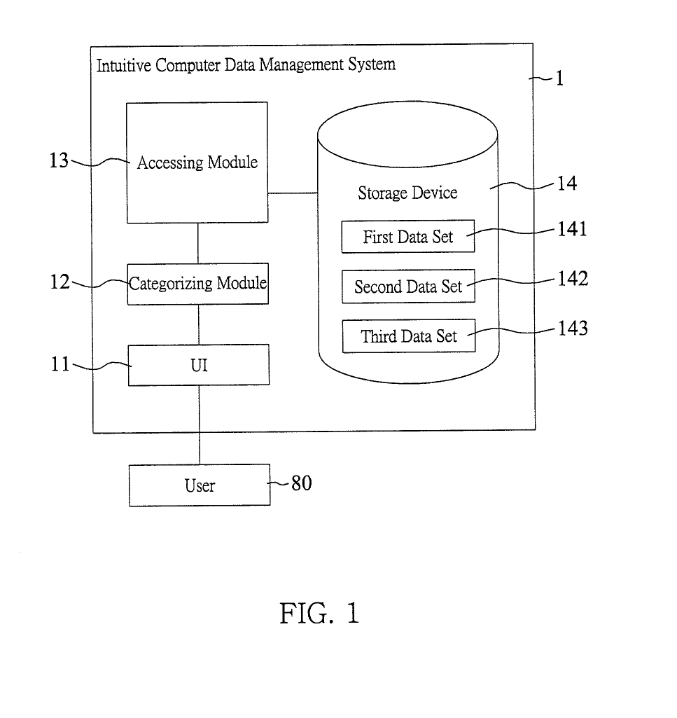

With reference to FIG. 1, the disclosed intuitive computer data management system 1 includes a UI (User Interface) 11, a categorizing module 12, an accessing module 13 and a storage device 14. In the current embodiment, the intuitive computer data management system 1 is implemented in a computer device comprising a CPU (Central Processing Unit), a computer readable storage device and other peripheral devices for accomplishing the desired functions (input devices such as a keyboard and a mouse and output devices such as a monitor and a printer). Electrical signals with concrete physical quantities are used to record or transmit information among the above-mentioned devices.

The UI 11, the categorizing module 12 and the accessing module 13 can be program modules stored in the storage device 14. After being read into and executed by the CPU, the desired functions can be achieved via relevant hardware operations and electrical signal transmissions. The storage device can be any computer readable data storage device, such as a HDD (Hard Disk Drive), memory or a floppy disk drive.

The UI 11 provides the user 80 at least one prompt so that the user 80 can follow the prompt to send an accessing request for the computer readable data in one action. In the embodiment, the so-called “one action” refers to the single action for inputting a request by hitting a key on the keyboard. The keys on the keyboard can be grouped into “basic keys” and “auxiliary keys”. The “basic keys” include F1 through F12 and the number keys 0 through 9, the four direction keys, Enter, ESC, PageUp and PageDown. The “auxiliary keys” include Backspace, +, −, Home, End, Ins, and Del.

It should be emphasized that the UI can accept other input methods from the user 80 in addition to the keyboard input. For example, the user can use a mouse to click and enter his request. He can also use other one-action input controllers, such as a digital pad or a voice recognition system, to input his request. Any person skilled in the art can make various equivalent modifications without departing from the spirit and scope of the invention.

After the user 80 enters his accessing request, the accessing request is processed by the categorizing module 12. The categorizing module 12 automatically determines the data type so as to determine which data set should be accessed. For example, if the user 80 is using a word processor, the categorizing module 12 automatically determines that it is a document file and reads in the document file from the document data set. Alternatively, it can read in a document file from the data set selected by the user 80. As another example, if the data are E-mail (Electronic Mail) messages, the categorizing module 12 automatically determines that they should be stored in E-mail data set. The categorizing module 12 sends the classification result to the accessing module for performing data access.

Since the categorizing module 12 can automatically classify data, the user 80 does not need to determine where to store or read data. In other words, the user 80 does not need to have such concepts as “file”, “path” and “file folder” in order to use and manage data in the computer.

The storage device 14 stores three data sets, namely, a first data set 141, a second data set 142, and a third data set 143. Each data set has at least one datum, such as a word document, an image or an E-mail message. The data within the same data set are of the same type. For example, in the current embodiment, the first data set 141 stores document type data, the second data set 142 stores image type data, and the third data set 143 stores E-mail message data. It should be emphasized that any person skilled in the art can make equivalent modification to meet the actual needs. For example, if there is a tremendous amount of document data, several data sets can be employed to store the document data. When a new data type appears, a new data set is established to store such data. In addition, if some application can process different types of data, those different types of data can be stored in the same data set for the user to select.

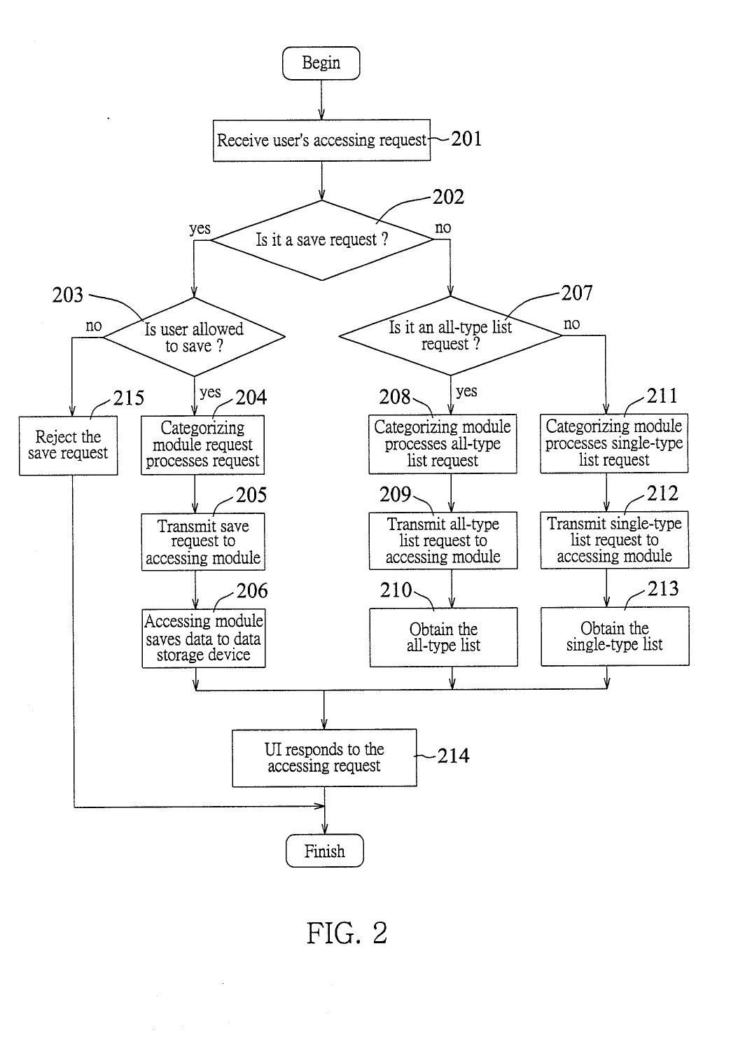

With reference to FIG. 2, the intuitive computer data management method 2 according to the preferred embodiment of the invention uses the above-mentioned UI 11 to receive the accessing request from the user 80 in step 201. In this embodiment, the UI 11 provides prompts for the selection items so that users can use number keys to select desired items in one single action.

Step 202 determines whether the user's request is a save request or a read request. If it is a save request, then step 203 starts to determine whether the user is authorized to save data. If the user can save data, then the categorizing module 12 processes the save request from the user in step 204. As described before, the categorizing module 12 automatically determine the data type to determine which data set the data should be stored in.

In step 203, if the user is not allowed to save files, e.g. when the data that the user is using are read only data, then the method 2 enters step 215 to reject the user's save request.

If the accessing request from the user is a read request, then step 207 starts to determine whether the read request is a single-type list request or an all-type list request. The single-type list request here is the request of reading in data of one type. The user will get a list of data belonging to one single type. The all-type list request is the request of reading in data of all types. The user will then get a list of data of all types in the same set.

According to a preferred embodiment of the invention, the intuitive computer data management system processes the accessing requests entered by a user according to the accessing request type (save request, single-type list request or all-type list request) input from the user. In the method 2, step 204 processes the save request, step 208 processes the all-type list request, and step 211 processes the single-type list request. Among these steps, the categorizing module 12 automatically determines the data type as described before.

After the user's accessing request is processed, it is then sent to the accessing module 13. In the embodiment, step 205 transmits the save request to the accessing module 13. Step 209 transmits the all-type list request to the accessing module 13. Step 212 transmits the single-type list request to the accessing module 13. Since the categorizing module 12 and the accessing module are program modules in this embodiment, a skilled person can use different methods to transmit all types of data and requests in accordance with the actual situation. For example, one can control the parameters in a function for transmitting various requests. Or each request is represented by a system event and is sent to the corresponding program module by the operating system.

The accessing module 13 reads in data from or saves data to the storage device 14 according to the request. In the embodiment, step 206 saves data to the storage device 14 according to the save request. Step 210 reads in a list of data of all types from the same data set in the storage device according to the all-type list request. Step 213 reads in a list of data of one type from the storage device 14 according to the single-type list request.

When the accessing module successfully accesses the data in the storage device, the system then responds to the user's accessing request in step 214. The way the system responds can be displaying a successful save/read message or directly starting the corresponding application for the data in order to open the file.

To make the content of the invention be more easily understood, we explain how the intuitive computer data management system help users read in data from the storage device according to the preferred embodiment of the invention.

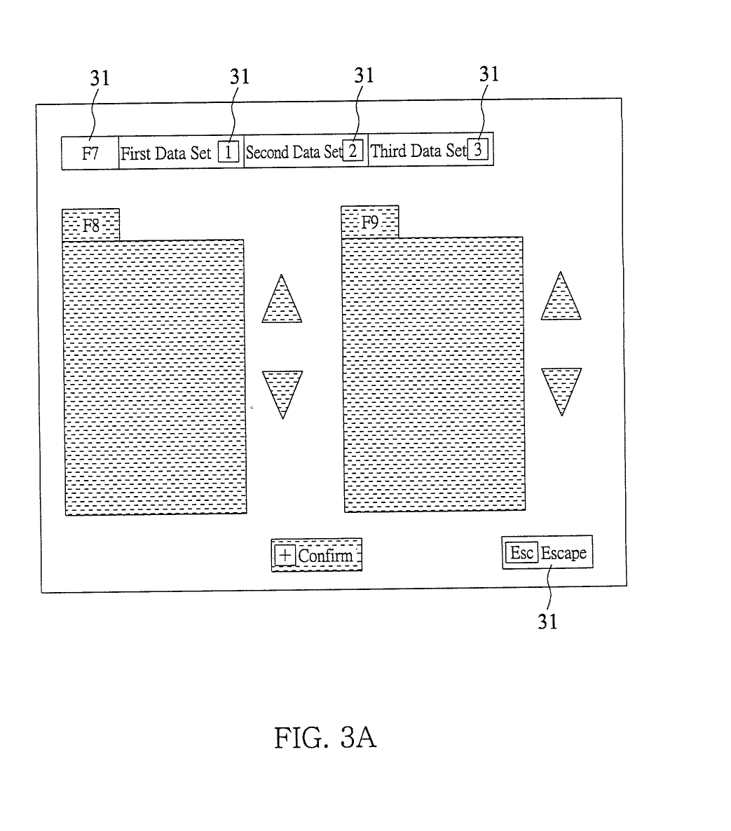

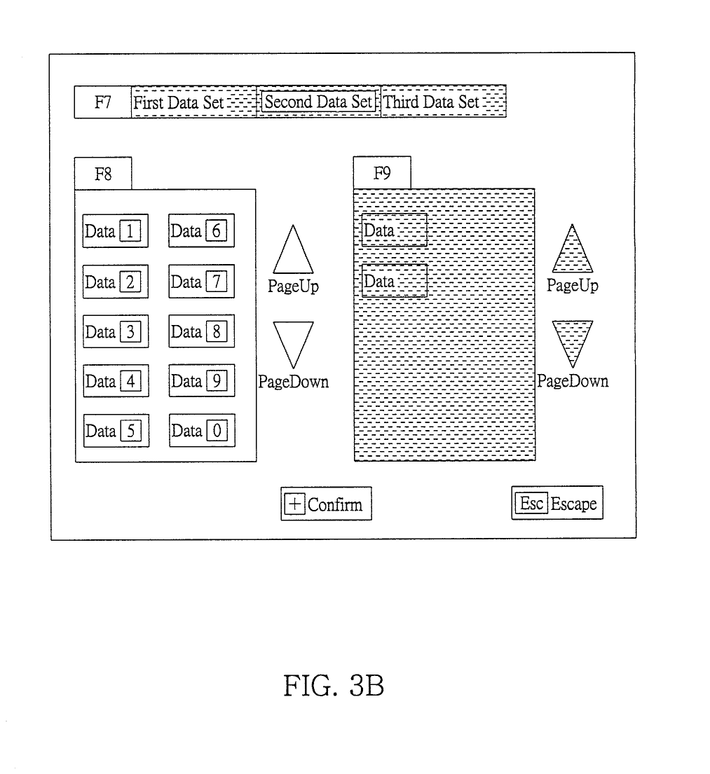

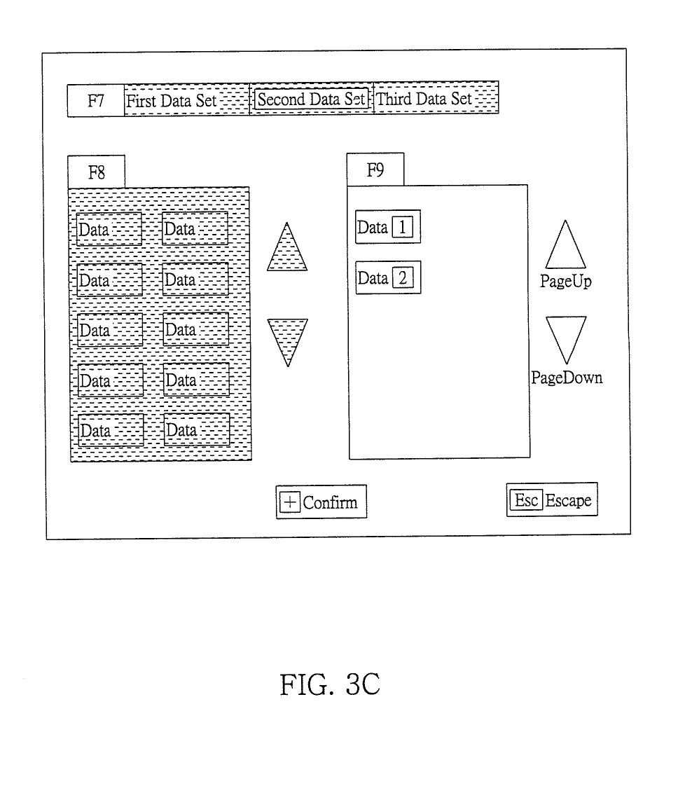

When a user 80 uses the disclosed system, the UI 11 displays a screen on a monitor as shown in FIG. 3A. In FIG. 3A, the gray area is an inactive area where the user cannot operate. The white area is the active area where the user can operate. The UI 11 as shown in FIG. 3A provides prompts 31 to the user. For example, the user can use the number key 1 to select a first data set, the number key 2 to select a second data set, and the number key 3 to select a third data set.

When the user hits the number key 2 to select the second data set 143, the UI 11 displays a screen as shown in FIG. 3B on the monitor. In the drawing, the UI 11 provides prompts 31 to the user. The user can follow the prompts 31 to use the number keys 0 through 9 to select data shown in the area on the left and PageUp and PageDown to view other data in a second data set yet shown on the screen. The user can also press F7 to select data in other data sets.

Since in the current embodiment, the same data set stores data of the same type. When the user selects the second data set 143, he can see a list of the data of all types in the second data set 143. That is, the user can send an all-type list request described before.

Once the user selects a data file, the data will be shown in the area on the right of FIG. 3B. At the moment, if the user presses the + key, it means that the selected data are read.

After data are selected, the user can follow the prompts on the screen and presses F9 to switch to the area on the right. As shown in FIG. 3C, when the user presses F9, the active area is switched to the area on the right. At this moment, the user can use the number keys to select data he wants to cancel. The user can press + to confirm that the selected data have been read.

Therefore, the intuitive computer data management system disclosed herein can automatically provide appropriate prompts to a user. The user then only needs to follows the prompts to operate the computer without memorizing any operation procedures or hot key combinations.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An intuitive computer data management system that helps a user to manage computer readable data, comprising:
a UI (User Interface), which provides the user at least one prompt for the user to follow the prompt to send an accessing request for the computer readable data in one action;
a categorizing module, which automatically determines the type of the computer readable data according to the accessing request; and
an accessing module, which accesses the computer readable data according to the type of the computer readable data.

2. The system of claim 1, wherein
the accessing request is a save request to store the computer readable data; and
the accessing module stores the computer readable data to a corresponding data set according to the type of the computer readable data.

3. The system of claim 1, wherein
the accessing request is a single-type list request to read in the computer readable data of the desired type; and
the accessing module reads in the computer readable data of the desired type from the corresponding data set according to the computer readable data type and displays the single-type list on the UI for the user.

4. The system of claim 1, wherein
the accessing request is an all-type list request to read in a plurality of computer readable data; and
the accessing module reads in the computer readable data of all types from the corresponding data sets according to the computer readable data types and displays the all-type list on the UI for the user.

5. The system of claim 1, wherein the one action refers to the action of hitting one key on a keyboard.

6. The system of claim 1 further comprising a storage device for storing computer readable data.

7. An intuitive computer management method that helps a user to manage computer readable data, comprising:
providing the user at least one prompt so that the user can follow the prompt to send an accessing request for the computer readable data in one action;
determining the type of the computer readable data automatically according to the accessing request; and
accessing the computer readable data according to the type of the computer readable data.

8. The method of claim 7, wherein
the accessing request is a save request to store the computer readable data; and
the accessing step stores the computer readable data to a corresponding data set according to the type of the computer readable data.

9. The method of claim 7, wherein
the accessing request is a single-type list request to read in the computer readable data of the desired type; and
the accessing step reads in the computer readable data of the desired type from the corresponding data set according to the computer readable data type.

10. The method of claim 7, wherein
the accessing request is an all-type list request to read in a plurality of computer readable data; and
the accessing step reads in the computer readable data of all types from the corresponding data sets according to the computer readable data types.

11. The method of claim 7, wherein the one action refers to the action of hitting one key on a keyboard.

12. A storage medium storing program codes used to direct an electronic device to perform the following acts:
providing a user at least one prompt so that the user can follow the prompt to send an accessing request for at least one computer readable data in one action;
determining the type of the computer readable data automatically according to the accessing request; and
accessing the computer readable data according to the type of the computer readable data.

13. The storage medium of claim 12, wherein
the accessing request is a save request to store the computer readable data; and
the accessing act stores the computer readable data to a corresponding data set according to the type of the computer readable data.

14. The method of claim 12, wherein
the accessing request is a single-type list request to read in the computer readable data of the desired type; and
the accessing act reads in the computer readable data of the desired type from the corresponding data set according to the computer readable data type.

15. The method of claim 12, wherein
the accessing request is an all-type list request to read in a plurality of computer readable data; and
the accessing act reads in the computer readable data of all types from the corresponding data sets according to the computer readable data types.
